(19) United States
(12) Patent Application Publication
(10) Pub. No.: US 2007/0092636 A1
(43) Pub. Date: Apr. 26, 2007

(54) METHOD OF MAKING LIGHT EMITTING DEVICE HAVING A MOLDED ENCAPSULANT

(75) Inventors: D. Scott Thompson, Woodbury, MN (US); Catherine A. Leatherdale, Woodbury, MN (US); Larry D. Boardman, Woodbury, MN (US); Andrew J. Ouderkirk, Woodbury, MN (US); Fedja Kecman, St. Louis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/551,309

(22) Filed: Oct. 20, 2006

Related U.S. Application Data
(60) Provisional application No. 60/729,576, filed on Oct. 24, 2005.

(51) Int. Cl. B05D 5/06; B05D 5/12

(52) U.S. Cl. 427/66

(57) ABSTRACT

Disclosed herein is a method of making a light emitting device comprising an LED and a molded silicon-containing encapsulant. The method includes contacting the LED with a photopolymerizable composition containing a silicon-containing resin having silicon-bonded hydrogen and aliphatic unsaturation and a metal-containing catalyst that may be activated by actinic radiation. Photopolymerization of the photopolymerizable composition is then carried out to form the encapsulant. At some point before polymerization is complete, a mold is used to impart a predetermined shape to the encapsulant.

### CROSS REFERENCE TO RELATED APPLICATIONS

This application claims the benefit of U.S. Provisional Patent Application No. 60/729,576, filed Oct. 24, 2005, the disclosure of which is incorporated by reference herein in its entirety.

### FIELD OF THE INVENTION

The invention relates to a method of making a light emitting device having an LED die and an encapsulant, wherein the encapsulant is molded and comprises a silicon-containing resin.

### BACKGROUND

Encapsulation of semiconductor devices has traditionally been accomplished using a transfer molding process in which a thermoset molding compound (typically a solid epoxy preform) is dielectrically preheated and then placed into a pot of a molding tool. A transfer cylinder, or plunger, is used to push the molding compound into a runner system and gates of the mold. The molding compound then flows over the chips, wirebonds, and leadframes, encapsulating the semiconductor device. Most transfer molding processes suffer from significant problems arising from high operating temperatures (the molding compound is a solid at room temperature) and high pressures required to fill the mold (even in the melt state, the molding compound has a high viscosity, and the viscosity increases further with reaction). These problems can lead to incomplete mold filling, thermal stresses (since the reaction temperature is much higher than the final use temperature), and wire sweep.

### SUMMARY

Disclosed herein is a method of making an encapsulated LED with a molded silicon- containing encapsulant at low temperature using low to moderate viscosity resins. The method avoids problems associated with wire sweep as described above.

The method disclosed herein is for making a light emitting device, the method comprising the following: providing an LED; contacting the LED with a photopolymerizable composition comprising a silicon-containing resin comprising silicon-bonded hydrogen and aliphatic unsaturation and a metal-containing catalyst that may be activated by actinic radiation; and contacting the photopolymerizable composition with a mold. After contacting with the mold, actinic radiation may be applied to the photopolymerizable composition, wherein the actinic radiation is at a wavelength of 700 nm or less and initiates hydrosilylation within the silicon-containing resin, the hydrosilylation comprising reaction between the silicon-bonded hydrogen and the aliphatic unsaturation. The actinic radiation may be used to form a partially polymerized composition, such that the method may further comprise heating to further initiate hydrosilylation within the silicon-containing resin. Optionally, the photopolymerizable composition may be heated to a temperature of less than about 150° C. before contacting it with the mold.

The method may also comprise applying actinic radiation to the photopolymerized composition before contacting with the mold in order to form a partially polymerized composition. Then, after contacting with the mold, actinic radiation could be applied to the partially polymerized composition such that hydrosilylation is further initiated within the silicon-containing resin and a second partially polymerized composition is formed. The second partially polymerized composition may then be heated to further intiate hydrosilylation within the silicon-containing resin. It is also possible that, after contacting with the mold, hydrosilylation may be further initiated by heating, instead of by applying actinic radiation, the partially polymerized composition to a temperature of less than about 150° C.

The mold may be shaped to impart any useful structure, for example, a positive or negative lens, or some combination of macrostructures and/or microstructures.

These and other aspects of the invention will be apparent from the detailed description and drawings below. In no event should the above summary be construed as a limitation on the claimed subject matter, which subject matter is defined solely by the attached claims, as may be amended during prosecution.

### BRIEF DESCRIPTION OF DRAWINGS

FIG. 1 shows a schematic cross sectional view of an exemplary light emitting device having an unmolded encapsulant.

FIGS. 2-8 show views of exemplary light emitting devices wherein the encapsulant is molded.

The invention may be more completely understood in consideration of the following detailed description in connection with the Figures described above. The Figures are illustrative examples only.

### DETAILED DESCRIPTION

This application is related to U.S. patent application Ser. No. ______ by Thompson et al., entitled “Method of Making Light Emitting Device Having a Molded Encapsulant”, and filed of even date herewith (Docket 61404US007). This application is related to commonly assigned, co-pending U.S. patent application Ser. No. 11/252,336 by Boardman et al., entitled “Method of Making Light Emitting Device with Silicon-Containing Encapsulant”, and filed Oct. 17, 2005, which is a continuation-in-part of U.S. patent application Ser. No. 10/993,460, filed Nov. 18, 2004, now allowed; both of which are incorporated by reference herein in their entirety.

The method described herein employs a mold that comprises a mold material and can be shaped so as to impart a desired complimentary shape to the outer surface of the encapsulant. As used herein, “encapsulant” refers to an at least partially polymerized silicon-containing resin. Any material capable of being formed into a mold may be used, and in general, it is usually desirable for the mold material to have a glass transition temperature greater than the particular temperature(s) used in a method of making the light emitting device as described below. Examples of mold materials include polymeric materials such as fluoroelastomers, polyolefins, polystyrene, polyesters, polyurethanes, polyethers, polycarbonates, polymethyl methacrylate; and inorganic materials comprising ceramics, quartz, sapphire, metals, and certain glasses. Even organic-inorganic hybrid materials may be used as the mold; exemplary hybrid materials include fluorinated materials described by Choi et al. in Langmuir, Vol. 21, page 9390 (2005). The mold may be transparent such as a transparent ceramic; a transparent mold would be useful in cases where the actinic radiation is applied through the mold. The mold can also be non-transparent such as an opaque ceramic, an opaque plastic, or a metal. The mold can be fabricated by conventional machining, diamond turning, contact lithography, projection lithography, interference lithography, etching, or any other suitable technique. The mold may be an original master mold or a daughter mold thereof. Molding may be referred to as reactive embossing.

The surface of the mold that contacts the photopolymerizable composition, or the partially polymerized composition, may be coated with a release material in order to facilitate removal of the mold from the surface that has been molded. For example, with a steel or nickel mold, it may be useful to spray the molding surface with a 2 to 5 weight percent solution of a household detergent in water every 5 to 10 cycles. Fluorocarbon release agents can also be used. One light emitting device or a plurality of light emitting devices may be fabricated simultaneously using a single mold.

The mold may be shaped so as to impart any useful structure on the surface of the photopolymerizable composition or the partially polymerized composition. For example, the mold may be shaped so as to form a refractive lens on the LED. Lensing refers to the uniform (or nearly uniform) curvature of a substantial portion of the surface of the encapsulant to form a positive or negative lens, the diameter of which is approximately the size of the package or reflector cup. In general, a lensed surface can be characterized by a “radius of curvature.” The radius of curvature can be either positive, denoting a convex surface or negative denoting a concave surface or infinite denoting a flat surface. Lensing can improve light extraction by reducing the total internal reflections of light incident at the encapsulant-air interface. It can also change the angular distribution of light emitted from the light emitting device.

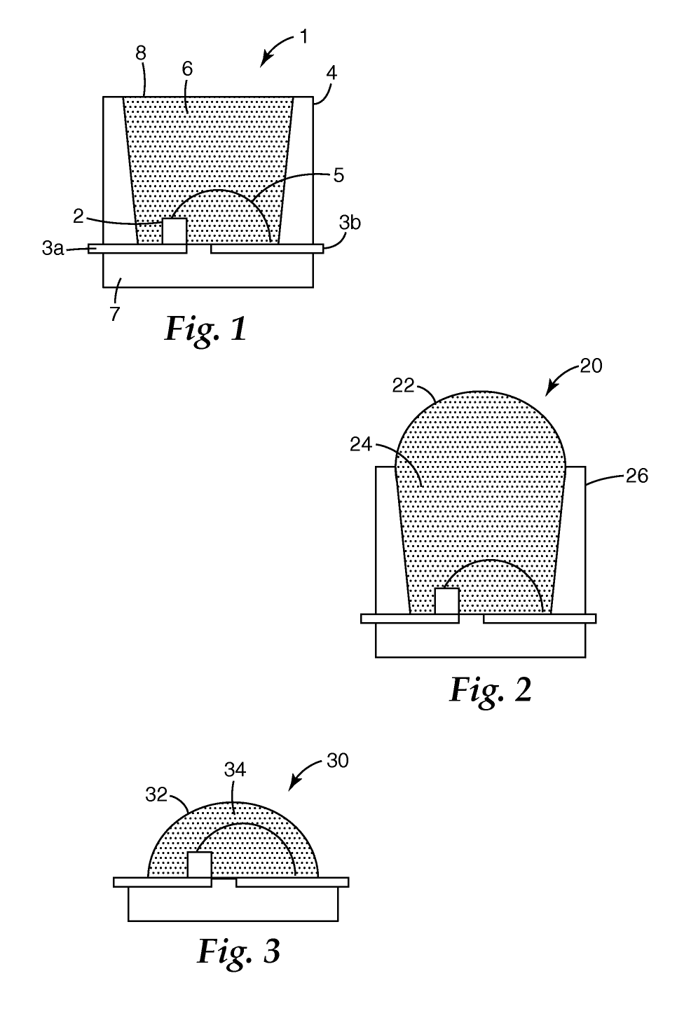

Referring to FIG. 1, light emitting device 10 comprising an unmolded encapsulant 6 is shown. LED 2 is mounted on a metallized contact 3a disposed on a substrate 7 in a reflector cup 4. LED 2 has one electrical contact on its lowermost surface and another on its uppermost surface, the latter of which is connected to a separate electrical contact 3b by a wire bond 5. A power source can be coupled to the electrical contacts to energize the LED. Surface 8 of encapsulant 6 is not molded. FIG. 2 shows a schematic cross-sectional view of exemplary light emitting device 20 in which surface 22 of encapsulant 24 is molded in the shape of a hemispherical lens approximately the size of the reflector cup 26. FIG. 3 shows a schematic cross-sectional view of another exemplary light emitting device 30, except that the device does not have a reflector cup. In this case, surface 32 of encapsulant 34 is also molded in the shape of a hemispherical lens.

The surface may also be shaped with macrostructures having a characteristic dimension that is smaller than the package size, but much larger than the wavelength of visible light. That is, each macrostructure may have a dimension of from 10 μm to 1 mm. The spacing or period between each macrostructure may also be from 10 μm to 1 mm (or about ⅓ the size of the LED package). Examples of macrostructures include surfaces that, when viewed in cross-section, appear to be shaped like a sine wave, triangular wave, square wave, rectified sine wave, saw tooth wave, cycloid (more generally curtate cycloid), or rippled. The periodicity of the macrostructures may be one- or two-dimensional. Surfaces with one-dimensional periodicity have repeat structures along only one major direction of the surface. In one particular example, the mold may comprise any of the Vikuiti™ Brightness Enhancement Films available from 3M Company.

The mold may be shaped to impart a lens structure capable of making a molded encapsulant that can generate a side-emission pattern. For example, the molded encapsulant has a central axis, and light entering the molded encapsulant is reflected and refracted and eventually exits in a direction substantially perpendicular to the central axis; examples of these types of side emitting lens shapes and devices are described in U.S. Pat. No. 6,679,621 B2 and U.S. Pat. No. 6,598,998 B2. For another example, the molded encapsulant has a generally planar surface, with a smoothly curved surface defining a vortex shape that extends into the encapsulant and has the shape of an equiangular spiral that forms into a cusp; an example of such a profile is described in U.S. Pat. No. 6,473,554 B1, particularly FIGS. 15, 16 and 16A.

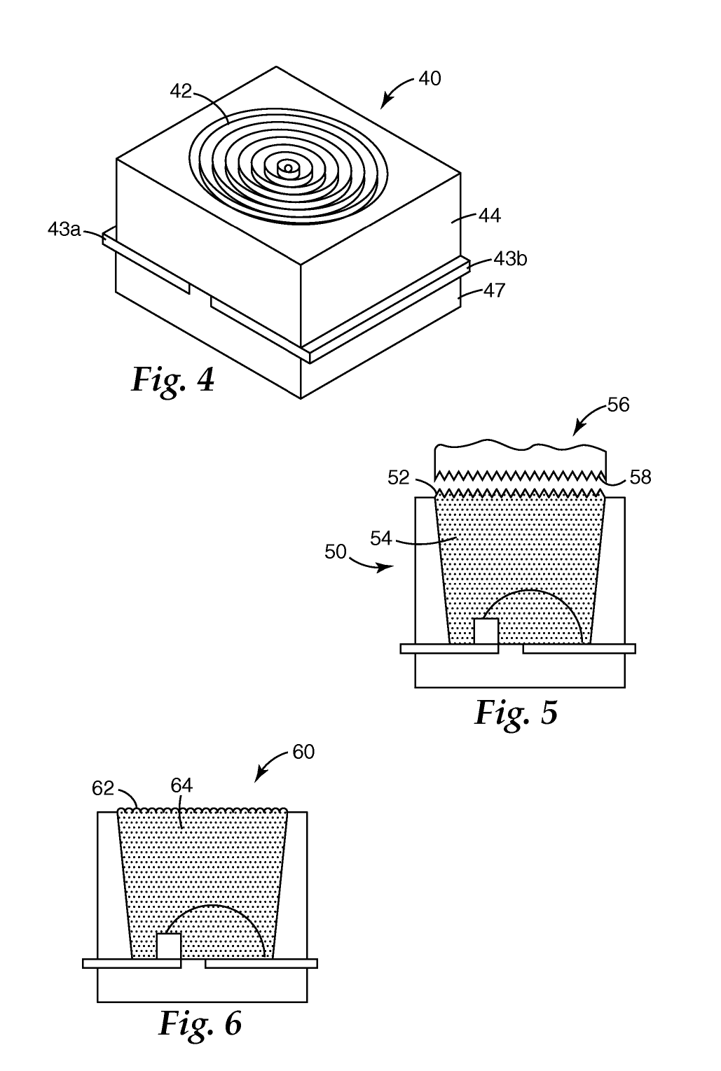

Surfaces with two-dimensional periodicity have repeat structures along any two orthogonal directions in the plane of the macrostructures. Examples of macrostructures with two-dimensional periodicity include random surfaces, two-dimensional sinusoids, arrays of cones, arrays of prisms such as cube-corners, and lenslet arrays. FIG. 4 shows an elevated view of another exemplary light emitting device 40 wherein surface 42 of the encapsulant is shaped as a Fresnal lens having generally circular symmetry and that can be designed to replicate the optical properties of any positive or negative lens while occupying much less volume than a solid lens. Also shown in FIG. 4 are metallized contacts 43a and 43b disposed on a substrate 47 in a reflector cup 44 (the LED and wire bond are not visible).

In general, the macrostructures do not need to be uniform in size across the surface. For example, they may get larger or smaller toward the edges of the package, or they may change shape. The surface may consist of any linear combination of shapes described herein.

The surface may also be shaped with microstructures having a characteristic dimension on a scale similar to the wavelengths of visible light. That is, each microstructure may have a dimension of from 100 nm to less than 10 μm. Light tends to diffract when it interacts with microstructured surfaces. Thus, the design of microstructured surfaces requires careful attention to the wave-like nature of light. Examples of microstructures are one- and two-dimensional diffraction gratings; one-, two-, or three-dimensional photonic crystals; binary optical elements; and “motheye” anti-reflection coatings. FIG. 5 shows a schematic cross-sectional view of exemplary light emitting device 50 wherein the surface 52 of encapsulant 54 is molded with linear prisms having one-dimensional periodicity. Mold 56 having surface 58 with a complimentary shape is also shown. FIG. 7 shows an elevated view of another exemplary light emitting device 70, wherein surface 72 of the encapsulant comprises an array of two-dimensional prisms. In FIG. 6, a schematic cross-sectional view of another exemplary light emitting device 60 is shown wherein surface 62 of encapsulant 64 is molded with microlenses.

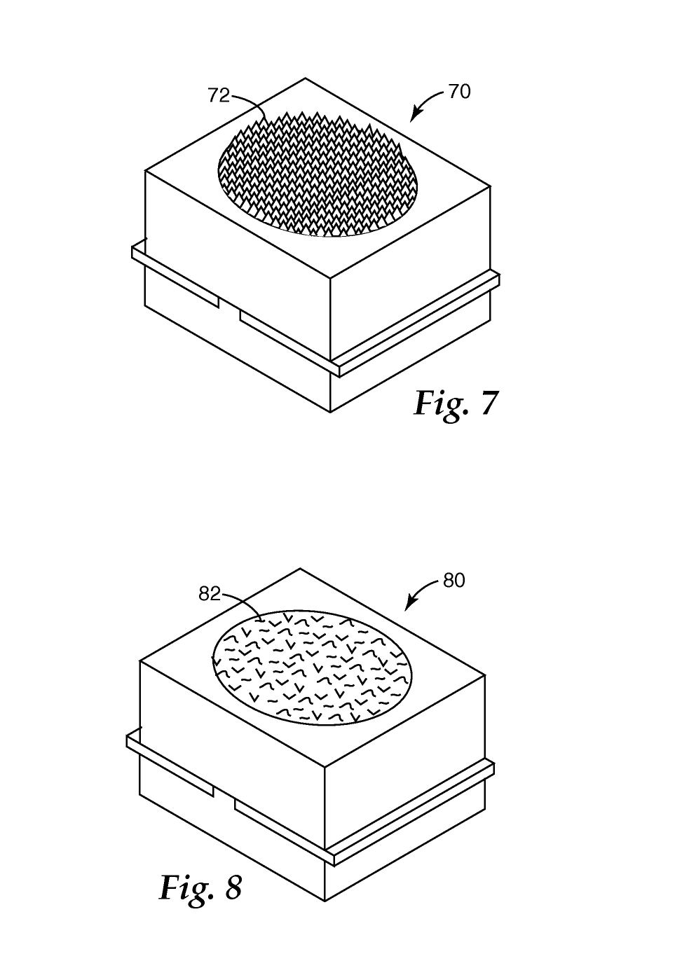

The microstructures do not need to be uniform in size across the surface. For example, the elements may get larger or smaller toward the edges of the package, or they may change shape. The surface may consist of any linear combination of shapes described herein. FIG. 8 shows an elevated view of another exemplary light emitting device 80, wherein surface 82 of the encapsulant comprises randomly disposed protrusions and depressions.

The surface of the encapsulant may comprise structures from all three size scales. All package surfaces will be lensed with some radius of curvature, which could be positive, negative, or infinite. A macrostructure or microstructure could be added to the lensed surface to further enhance light output or to optimize the angular distribution for a given application. A surface could even incorporate a microstructure on a macrostructure on a lensed surface.

The method described herein also includes providing a photopolymerizable composition comprising a silicon-containing resin comprising silicon-bonded hydrogen and aliphatic unsaturation. The silicon-containing resin can include monomers, oligomers, polymers, or mixtures thereof. It includes silicon-bonded hydrogen and aliphatic unsaturation, which allows for hydrosilylation (i.e., the addition of a silicon-bonded hydrogen across a carbon-carbon double bond or triple bond). The silicon-bonded hydrogen and the aliphatic unsaturation may or may not be present in the same molecule. Furthermore, the aliphatic unsaturation may or may not be directly bonded to silicon.

Preferred silicon-containing resins are those that provide an encapsulant, which can be in the form of a liquid, gel, elastomer, or a non-elastic solid, and are thermally and photochemically stable. For UV light, silicon-containing resins having refractive indices of at least 1.34 are preferred. For some embodiments, silicon-containing resins having refractive indices of at least 1.50 are preferred.

Preferred silicon-containing resins are selected such that they provide an encapsulant that is photostable and thermally stable. Herein, photostable refers to a material that does not chemically degrade upon prolonged exposure to actinic radiation, particularly with respect to the formation of colored or light absorbing degradation products. Herein, thermally stable refers to a material that does not chemically degrade upon prolonged exposure to heat, particularly with respect to the formation of colored or light absorbing degradation products. In addition, preferred silicon-containing resins are those that possess relatively rapid cure mechanisms (e.g., seconds to less than 30 minutes) in order to accelerate manufacturing times and reduce overall LED cost.

Examples of suitable silicon-containing resins are disclosed, for example, in U.S. Pat. No. 6,376,569 (Oxman et al.), U.S. Pat. No. 4,916,169 (Boardman et al.), U.S. Pat. No. 6,046,250 (Boardman et al.), U.S. Pat. No. 5,145,886 (Oxman et al.), U.S. Pat. No. 6,150,546 (Butts), and in U.S. Pat. Appl. Nos. 2004/0116640 (Miyoshi). A preferred silicon-containing resin comprises an organosiloxane (i.e., silicones), which includes organopolysiloxanes. Such resins typically include at least two components, one having silicon-bonded hydrogen and one having aliphatic unsaturation. However, both silicon-bonded hydrogen and olefinic unsaturation may exist within the same molecule.

In one embodiment, the silicon-containing resin can include a silicone component having at least two sites of aliphatic unsaturation (e.g., alkenyl or alkynyl groups) bonded to silicon atoms in a molecule and an organohydrogensilane and/or organohydrogenpolysiloxane component having at least two hydrogen atoms bonded to silicon atoms in a molecule. Preferably, a silicon-containing resin includes both components, with the silicone containing aliphatic unsaturation as the base polymer (i.e., the major organosiloxane component in the composition.) Preferred silicon-containing resins are organopolysiloxanes. Such resins typically comprise at least two components, at least one of which contains aliphatic unsaturation and at least one of which contains silicon-bonded hydrogen. Such organopolysiloxanes are known in the art and are disclosed in such patents as U.S. Pat. No. 3,159,662 (Ashby), U.S. Pat. No. 3,220,972 (Lamoreauz), U.S. Pat. No. 3,410,886 (Joy), U.S. Pat. No. 4,609,574 (Keryk), U.S. Pat. No. 5,145,886 (Oxman, et. al), and U.S. Pat. No. 4,916,169 (Boardman et. al). Curable one component organopolysiloxane resins are possible if the single resin component contains both aliphatic unsaturation and silicon-bonded hydrogen.

Organopolysiloxanes that contain aliphatic unsaturation are preferably linear, cyclic, or branched organopolysiloxanes comprising units of the formula R¹ₐR²_{b}SiO_{(4-a-b)/2} wherein: R¹ is a monovalent, straight-chained, branched or cyclic, unsubstituted or substituted hydrocarbon group that is free of aliphatic unsaturation and has from 1 to 18 carbon atoms; R² is a monovalent hydrocarbon group having aliphatic unsaturation and from 2 to 10 carbon atoms; a is 0, 1, 2, or 3; b is 0, 1, 2, or 3; and the sum a+b is 0, 1, 2, or 3; with the proviso that there is on average at least 1 R² present per molecule.

Organopolysiloxanes that contain aliphatic unsaturation preferably have an average viscosity of at least 5 mPa·s at 25° C.

Examples of suitable R¹ groups are alkyl groups such as methyl, ethyl, n-propyl, iso-propyl, n-butyl, iso-butyl, tert-butyl, n-pentyl, iso-pentyl, neo-pentyl, tert-pentyl, cyclopentyl, n-hexyl, cyclohexyl, n-octyl, 2,2,4-trimethylpentyl, n-decyl, n-dodecyl, and n-octadecyl; aromatic groups such as phenyl or naphthyl; alkaryl groups such as 4-tolyl; aralkyl groups such as benzyl, 1-phenylethyl, and 2-phenylethyl; and substituted alkyl groups such as 3,3,3-trifluoro-n-propyl, 1,1,2,2-tetrahydroperfluoro-n-hexyl, and 3-chloro-n-propyl.

Examples of suitable R² groups are alkenyl groups such as vinyl, 5-hexenyl, 1-propenyl, allyl, 3-butenyl, 4-pentenyl, 7-octenyl, and 9-decenyl; and alkynyl groups such as ethynyl, propargyl and 1-propynyl. In the present invention, groups having aliphatic carbon-carbon multiple bonds include groups having cycloaliphatic carbon-carbon multiple bonds.

Organopolysiloxanes that contain silicon-bonded hydrogen are preferably linear, cyclic or branched organopolysiloxanes comprising units of the formula R¹ₐH_{c}SiO_{(4-a-c)/2} wherein: R¹ is as defined above; a is 0, 1, 2, or 3; c is 0, 1, or 2; and the sum of a+c is 0, 1, 2, or 3; with the proviso that there is on average at least 1 silicon-bonded hydrogen atom present per molecule.

Organopolysiloxanes that contain silicon-bonded hydrogen preferably have an average viscosity of at least 5 mPa·s at 25° C.

Organopolysiloxanes that contain both aliphatic unsaturation and silicon-bonded hydrogen preferably comprise units of both formulae R¹ₐR²_{b}SiO_{(4-a-b)/2} and R¹ₐH_{c}SiO_{(4-a-c)/2}. In these formulae, R¹, R², a, b, and c are as defined above, with the proviso that there is an average of at least 1 group containing aliphatic unsaturation and 1 silicon-bonded hydrogen atom per molecule.

The molar ratio of silicon-bonded hydrogen atoms to aliphatic unsaturation in the silicon-containing resin (particularly the organopolysiloxane resin) may range from 0.5 to 10.0 mol/mol, preferably from 0.8 to 4.0 mol/mol, and more preferably from 1.0 to 3.0 mol/mol.

For some embodiments, organopolysiloxane resins described above wherein a significant fraction of the R¹ groups are phenyl or other aryl, aralkyl, or alkaryl are preferred, because the incorporation of these groups provides materials having higher refractive indices than materials wherein all of the R¹ radicals are, for example, methyl.

The disclosed compositions also include a metal-containing catalyst which enables the cure of the encapulating material via radiation-activated hydrosilylation. These catalysts are known in the art and typically include complexes of precious metals such as platinum, rhodium, iridium, cobalt, nickel, and palladium. The precious metal-containing catalyst preferably contains platinum. Disclosed compositions can also include a cocatalyst, i.e., the use of two or more metal-containing catalysts.

A variety of such catalysts is disclosed, for example, in U.S. Pat. No. 6,376,569 (Oxman et al.), U.S. Pat. No. 4,916,169 (Boardman et al.), U.S. Pat. No. 6,046,250 (Boardman et al.), U.S. Pat. No. 5,145,886 (Oxman et al.), U.S. Pat. No. 6,150,546 (Butts), U.S. Pat. No. 4,530,879 (Drahnak), U.S. Pat. No. 4,510,094 (Drahnak) U.S. Pat. No. 5,496,961 (Dauth), U.S. Pat. No. 5,523,436 (Dauth), U.S. Pat. No. 4,670,531 (Eckberg), as well as International Publication No. WO 95/025735 (Mignani).

Certain preferred platinum-containing catalysts are selected from the group consisting of Pt(II) β-diketonate complexes (such as those disclosed in U.S. Pat. No. 5,145,886 (Oxman et al.), (η⁵-cyclopentadienyl)tri(σ-aliphatic)platinum complexes (such as those disclosed in U.S. Pat. No. 4,916,169 (Boardman et al.) and U.S. Pat. No. 4,510,094 (Drahnak)), and C₇₋₂₀-aromatic substituted (η⁵-cyclopentadienyl)tri(σ-aliphatic)platinum complexes (such as those disclosed in U.S. Pat. No. 6,150,546 (Butts).

Such catalysts are used in an amount effective to accelerate the hydrosilylation reaction. Such catalysts are preferably included in the photopolymerizable composition in an amount of at least 1 part, and more preferably at least 5 parts, per one million parts of the photopolymerizable composition. Such catalysts are preferably included in the photopolymerizable composition in an amount of no greater than 1000 parts of metal, and more preferably no greater than 200 parts of metal, per one million parts of the photopolymerizable composition.

In addition to the silicon-containing resins and catalysts, the photopolymerizable composition can also include nonabsorbing metal oxide particles, semiconductor particles, phosphors, sensitizers, photoinitiators, antioxidants, catalyst inhibitors, and pigments. If used, such additives are used in amounts to produced the desired effect.

Particles that are included within the photopolymerizable composition can be surface treated to improve dispersibility of the particles in the resin. Examples of such surface treatment chemistries include silanes, siloxanes, carboxylic acids, phosphonic acids, zirconates, titanates, and the like. Techniques for applying such surface treatment chemistries are known.

Nonabsorbing metal oxide and semiconductor particles can optionally be included in the photopolymerizable composition to increase the refractive index of the encapsulant. Suitable nonabsorbing particles are those that are substantially transparent over the emission bandwidth of the LED. Examples of nonabsorbing metal oxide and semiconductor particles include, but are not limited to, Al₂O₃, ZrO₂, TiO₂, V₂O₅, ZnO, SnO₂, ZnS, SiO₂, and mixtures thereof, as well as other sufficiently transparent non-oxide ceramic materials such as semiconductor materials including such materials as ZnS, CdS, and GaN. Silica (SiO₂), having a relatively low refractive index, may also be useful as a particle material in some applications, but, more significantly, it can also be useful as a thin surface treatment for particles made of higher refractive index materials, to allow for more facile surface treatment with organosilanes. In this regard, the particles can include species that have a core of one material on which is deposited a material of another type. If used, such nonabsorbing metal oxide and semiconductor particles are preferably included in the photopolymerizable composition in an amount of no greater than 85 wt-%, based on the total weight of the photopolymerizable composition. Preferably, the nonabsorbing metal oxide and semiconductor particles are included in the photopolymerizable composition in an amount of at least 10 wt-%, and more preferably in an amount of at least 45 wt-%, based on the total weight of the photopolymerizable composition. Generally the particles can range in size from 1 nanometer to 1 micron, preferably from 10 nanometers to 300 nanometers, more preferably, from 10 nanometers to 100 nanometers. This particle size is an average particle size, wherein the particle size is the longest dimension of the particles, which is a diameter for spherical particles. It will be appreciated by those skilled in the art that the volume percent of metal oxide and/or semiconductor particles cannot exceed 74 percent by volume given a monomodal distribution of spherical particles.

Phosphors can optionally be included in the photopolymerizable composition to adjust the color emitted from the LED. As described herein, a phosphor consists of a fluorescent material. The fluorescent material could be inorganic particles, organic particles, or organic molecules or a combination thereof. Suitable inorganic particles include doped garnets (such as YAG:Ce and (Y,Gd)AG:Ce), aluminates (such as Sr₂Al₁₄O₂₅:Eu, and BAM:Eu), silicates (such as SrBaSiO:Eu), sulfides (such as ZnS:Ag, CaS:Eu, and SrGa₂S₄:Eu), oxy-sulfides, oxy-nitrides, phosphates, borates, and tungstates (such as CaWO₄). These materials may be in the form of conventional phosphor powders or nanoparticle phosphor powders. Another class of suitable inorganic particles is the so-called quantum dot phosphors made of semiconductor nanoparticles including Si, Ge, CdS, CdSe, CdTe, ZnS, ZnSe, ZnTe, PbS, PbSe, PbTe, InN, InP, InAs, AlN, AlP, AIAs, GaN, GaP, GaAs and combinations thereof. Generally, the surface of each quantum dot will be at least partially coated with an organic molecule to prevent agglomeration and increase compatibility with the binder. In some cases the semiconductor quantum dot may be made up of several layers of different materials in a core-shell construction. Suitable organic molecules include fluorescent dyes such as those listed in U.S. Pat. No. 6,600,175 (Baretz et al.). Preferred fluorescent materials are those that exhibit good durability and stable optical properties. The phosphor layer may consist of a blend of different types of phosphors in a single layer or a series of layers, each containing one or more types of phosphors. The inorganic phosphor particles in the phosphor layer may vary in size (e.g., diameter) and they may be segregated such that the average particle size is not uniform across the cross-section of the siloxane layer in which they are incorporated. If used, the phosphor particles are preferably included in the photopolymerizable composition in an amount of no greater than 85 wt-%, and in an amount of at least 1 wt-%, based on the total weight of the photopolymerizable composition. The amount of phosphor used will be adjusted according to the thickness of the siloxane layer containing the phosphor and the desired color of the emitted light.

Sensitizers can optionally be included in the photopolymerizable composition to both increase the overall rate of the curing process (or hydrosilylation reaction) at a given wavelength of initiating radiation and/or shift the optimum effective wavelength of the initiating radiation to longer values. Useful sensitizers include, for example, polycyclic aromatic compounds and aromatic compounds containing a ketone chromaphore (such as those disclosed in U.S. Pat. No. 4,916,169 (Boardman et al.) and U.S. Pat. No. 6,376,569 (Oxman et al.)). Examples of useful sensitizers include, but are not limited to, 2-chlorothioxanthone, 9,10-dimethylanthracene, 9,10-dichloroanthracene, and 2-ethyl-9,10-dimethylanthracene. If used, such sensitizers are preferably included in the photopolymerizable composition in an amount of no greater than 50,000 parts by weight, and more preferably no greater than 5000 parts by weight, per one million parts of the composition. If used, such sensitizers are preferably included in the photopolymerizable composition in an amount of at least 50 parts by weight, and more preferably at least 100 parts by weight, per one million parts of the composition.

Photoinitiators can optionally be included in the photopolymerizable composition to increase the overall rate of the curing process (or hydrosilylation reaction). Useful photoinitiators include, for example, monoketals of α-diketones or α-ketoaldehydes and acyloins and their corresponding ethers (such as those disclosed in U.S. Pat. No. 6,376,569 (Oxman et al.)). If used, such photoinitiators are preferably included in the photopolymerizable composition in an amount of no greater than 50,000 parts by weight, and more preferably no greater than 5000 parts by weight, per one million parts of the composition. If used, such photoinitiators are preferably included in the photopolymerizable composition in an amount of at least 50 parts by weight, and more preferably at least 100 parts by weight, per one million parts of the composition.

Catalyst inhibitors can optionally be included in the photopolymerizable composition to further extend the usable shelf life of the composition. Catalyst inhibitors are known in the art and include such materials as acetylenic alcohols (for example, see U.S. Pat. No. 3,989,666 (Niemi) and U.S. Pat. No. 3,445,420 (Kookootsedes et al.)), unsaturated carboxylic esters (for example, see U.S. Pat. No. 4,504,645 (Melancon), U.S. Pat. No. 4,256,870 (Eckberg), U.S. Pat. No. 4,347,346 (Eckberg), and U.S. Pat. No. 4,774,111 (Lo)) and certain olefinic siloxanes (for example, see U.S. Pat. No. 3,933,880 (Bergstrom), U.S. Pat. No. 3,989,666 (Niemi), and U.S. Pat. No. 3,989,667 (Lee et al.). If used, such catalyst inhibitors are preferably included in the photopolymerizable composition in an amount up to about ten times the metal-containing catalyst on a mole basis.

The method described herein comprises providing an LED. The LED is a diode that emits light in the visible, ultraviolet, and/or infrared regions. The LED may comprise a single LED such as a monochrome LED, or it may comprise more than one LED. In some cases, it may be useful for the LED to emit light of from 350 to 500 nm, for example, when the actinic radiation is applied by activating the LED itself. The LED includes incoherent epoxy-encased semiconductor devices marketed as “LEDs”, whether of the conventional or super-radiant variety. Vertical cavity surface emitting laser diodes are another form of LED. An “LED die” is an LED in its most basic form, i.e., in the form of an individual component or chip made by semiconductor wafer processing procedures. The individual layers and other functional elements of the component or chip are typically formed on the wafer scale, the finished wafer finally being diced into individual piece parts to yield a multiplicity of LED dies. The LED can include electrical contacts suitable for application of power to energize the device.

Any suitable light emitting device may be made according to the method described herein. In one example, the light emitting device is a white light source having a direct emissive configuration of different colored LEDs, e.g., red, green, and blue; or blue and yellow. In another example, the light emitting device may comprise a single LED and a phosphor that is attached or embedded in close proximity to the LED. The LED generates light in a narrow range of wavelengths such that the light impinges upon and excites the phosphor material to produce visible light. The phosphor material can comprise one or a mixture or combination of distinct phosphor materials, and the light emitted by the phosphor material can include a plurality of narrow emission lines distributed over the visible wavelength range such that the emitted light appears substantially white to the unaided human eye. The phosphor material may be applied to the LED as part of the photopolymerizable composition. Alternatively, the phosphor material may be applied to the LED in a separate step, for example, the phosphor may be coated onto the LED prior to contacting the LED with the photopolymerizable composition. An example of a phosphor-LED, or PLED, is a blue LED illuminating a phosphor that converts blue to both red and green wavelengths. A portion of the blue excitation light is not absorbed by the phosphor, and the residual blue excitation light is combined with the red and green light emitted by the phosphor. Another example of a PLED is UV-LED illuminating a phosphor that absorbs and converts UV light to red, green, and blue light. Organopolysiloxanes where the R¹ groups are small (as described below) and have minimal UV absorption, for example methyl, are preferred for UV-LEDs. It will be apparent to one skilled in the art that competitive absorption of the actinic radiation by the phosphor will decrease absorption by the photoinitiators or metal-containing catalyst, slowing or even preventing cure if the system is not carefully constructed.

The LED may be packaged in a variety of configurations. For example, the LED may be surface mounted or side mounted in ceramic or polymeric package, which may or may not include a reflecting cup. The LED may also be mounted on circuit board or on a plastic electronic substrate.

The method disclosed herein also utilizes organosiloxane compositions that are cured by metal-catalyzed hydrosilylation reactions between groups incorporating aliphatic unsaturation and silicon-bonded hydrogen, which are bonded to the organosiloxane components. The metal-containing catalysts used herein can be activated by actinic radiation. The advantages of initiating hydrosilylation using catalysts activated by actinic radiation include (1) the ability to cure the photopolymerizable composition without subjecting the LED, the substrate to which it is attached, or any other materials present in the package or system, to potentially harmful temperatures, (2) the ability to formulate one-part photopolymerizable compositions that display long working times (also known as bath life or shelf life), (3) the ability to cure the photopolymerizable composition on demand at the discretion of the user, and (4) the ability to simplify the formulation process by avoiding the need for two-part formulations as is typically required for thermally curable hydrosilylation compositions.

The disclosed method involves the use of actinic radiation having a wavelength of less than or equal to 700 nanometers (nm). Thus, the disclosed methods are particularly advantageous to the extent they avoid harmful temperatures. Preferably, the disclosed methods involve the application of actinic radiation at a temperature of less than 120° C., more preferably, at a temperature of less than 60° C., and still more preferably at a temperature of 25° C. or less.

Actinic radiation used in the disclosed methods includes light of a wide range of wavelengths less than or equal to 700 nm, including visible and UV light, but preferably, the actinic radiation has a wavelength of of 600 nm or less, and more preferably from 200 to 600 nm., and even more preferably, from 250 to 500 nm. Preferably, the actinic radiation has a wavelength of at least 200 nm, and more preferably at least 250 nm.

Examples of sources of actinic radiation include tungsten halogen lamps, xenon arc lamps, mercury arc lamps, incandescent lamps, germicidal lamps, and fluorescent lamps. In certain embodiments, the source of actinic radiation is the LED.

As described above, method disclosed herein comprises the following: providing an LED; contacting the LED with a photopolymerizable composition comprising a silicon-containing resin comprising silicon-bonded hydrogen and aliphatic unsaturation and a metal-containing catalyst that may be activated by actinic radiation; and contacting the photopolymerizable composition with a mold. Optionally, the photopolymerizable composition may be heated to a temperature of less than about 150° C. before contacting it with the mold. Heating in this manner would reduce the viscosity of the photopolymerizable composition and facilitate contact between the composition and the mold.

After contacting with the mold, actinic radiation may be applied to the photopolymerizable composition, wherein the actinic radiation is at a wavelength of 700 nm or less and initiates hydrosilylation within the silicon-containing resin, the hydrosilylation comprising reaction between the silicon-bonded hydrogen and the aliphatic unsaturation. In this case, the actinic radiation may be used to form a partially polymerized composition or a substantially polymerized composition. At a later time, hydrosilylation may be further intiated by applying heat to the partially polymerized composition in order to form a substantially polymerized composition.

Forming a partially polymerized composition in the manner described above may be useful in order to gel the silicon-containing resin and control settling of any additional components such as particles, phosphors, etc. which may be present in the encapsulant. Controlled settling of the particles or phosphors may be used to achieve specific useful spatial distributions of the particles or phosphors within the encapsulant. For example, the method may allow controlled settling of particles enabling formation of a gradient refractive index distribution that may enhance LED efficiency or emission pattern. It may also be advantageous to allow partial settling of phosphor such that a portion of the encapsulant is clear and other portions contain phosphor. In this case, the clear portion of encapsulant can be shaped to act as a lens for the emitted light from the phosphor.

Other than to control settling, the step of heating after actinic radiation is applied may be used to accelerate formation of the encapsulant, or to decrease the amount of time the encapsulant is exposed to actinic radiation during the previous step. Any heating means may be used such as an infrared lamp, a forced air oven, or a heating plate. If applied, heating may be at less than 150° C., or more preferably at less than 100° C., and still more preferably at less than 60° C.

Actinic radiation may also be applied to the photopolymerizable composition before contacting it with the mold. This method comprises: providing a light emitting diode; contacting the light emitting diode with a photopolymerizable composition comprising: a silicon-containing resin comprising silicon-bonded hydrogen and aliphatic unsaturation, and a metal-containing catalyst that may be activated by actinic radiation; applying actinic radiation to the photopolymerizable composition, wherein the actinic radiation is at a wavelength of 700 nm or less and initiates hydrosilylation within the silicon-containing resin, thereby forming a partially polymerized composition, the hydrosilylation comprising reaction between the silicon-bonded hydrogen and the aliphatic unsaturation; and contacting the partially polymerized composition with a mold.

In this case, actinic radiation may be applied to the partially polymerized composition after contacting it with the mold, wherein the actinic radiation applied to the partially polymerized composition is at a wavelength of 700 nm or less and further initiates hydrosilylation within the silicon-containing resin. In this case, the actinic radiation may be used to form a second partially polymerized composition or a substantially polymerized composition. At a later time, hydrosilylation may be further intiated by applying heat to the second partially polymerized composition in order to form a substantially polymerized composition.

It is also possible to heat the partially polymerized composition to a temperature of less than about 150° C. after contacting it with the mold, wherein heating further initiates hydrosilylation within the silicon-containing resin. This heating step may be used to form a second partially polymerized composition or a substantially polymerized composition.

A sufficient amount of actinic radiation is applied to the silicon-containing resin for a time to form an at least partially cured encapsulant. A partially cured encapsulant means that at least 5 mole percent of the aliphatic unsaturation is consumed in a hydrosilylation reaction. Preferably, a sufficient amount of the actinic radiation is applied to the silicon-containing resin for a time to form a substantially cured encapsulant. A substantially cured encapsulant means that greater than 60 mole percent of the aliphatic unsaturation present in the reactant species prior to reaction has been consumed as a result of the light activated addition reaction of the silicon-bonded hydrogen with the aliphatic unsaturated species. Preferably, such curing occurs in less than 30 minutes, more preferably in less than 10 minutes, and even more preferably in less than 5 minutes or less than 1 minute. In certain embodiments, such curing can occur in less than 10 seconds.

In some embodiments, the metal-containing catalyst may comprise platinum. In other embodiments, the photopolymerizable composition may be at a temperature of from about 30° C. to about 120° C. In other embodiments, the metal-containing catalyst may comprise platinum, and the photopolymerizable composition may be at a temperature of from about 30° C. to about 120° C.

In some cases, the method disclosed herein may further comprise the step of heating at a temperature of from about 30° C. to about 120° C. before actinic radiation is applied.

### EXAMPLES

Mounting Blue LED Die in a Ceramic Package

Into a Kyocera package (Kyocera America, Inc., Part No. KD-LA2707-A) is bonded a Cree XB die (Cree Inc., Part No. C460XB290-0103-A) using a water based halide flux (Superior No. 30, Superior Flux & Mfg. Co.). The LED device is completed by wire bonding (Kulicke and Soffa Industries, Inc. 4524 Digital Series Manual Wire Bonder) the Cree XB die using 1 mil gold wire. The peak emission wavelength of the LED is 455-457 nm.

### Example 1

To 10.00 g of H₂C═CH—Si(CH₃)₂O—[Si(CH₃)₂O]₈₀—[Si(C₆H₅)₂O]₂₆—Si(CH₃)₂—CH═CH₂ (available from Gelest as PDV-2331) is added a 25 μL aliquot of a solution of 10 mg of Pt{[H₂C═CH—Si(CH₃)₂]O}₂ in 10 mL of heptane. To 1.00 g of this composition is added an additional 1.50 g of PDV-2331, 0.26 g of H(CH₃)₂SiO—[Si(CH₃)HO]₁₅—[Si(CH₃)(C₆H₅)O]₁₅—Si(CH₃)₂H (available from Gelest as HPM-502), and a 25 μL aliquot of a solution of 33 mg of CH₃CpPt(CH₃)₃ (from Strem Chemicals) in 1 mL of toluene. The mixture is degassed under vacuum, and the final composition was labeled Encapsulant A.

A small drop of Encapsulant A is placed into a blue LED device described above using the tip of a syringe needle such that the LED and wire bond are covered and the device is filled to level to the top of the reflector cup. The siloxane encapsulant is irradiated for 1 minute under a UVP Blak-Ray Lamp Model XX-15 fitted with two 16-inch Philips F15T8/BL 15 W bulbs emitting at 365 nm from a distance of 20 mm from the encapsulated LED. A piece of brightness enhancement film (BEF II) available from 3M is pressed into the partially cured encapsulant. The partially cured encapsulant is then irradiated for a further 5 minutes. The BEF film is peeled off the encapsulant. Examination of the light emitting device using a microscope shows a series of prisms on the surface of the encapsulant.

### Example 2

A blue LED device is filled with Encapsulant A as described in Example 1. The siloxane encapsulant is irradiated as described in Example 1 for 1 minute. A piece of BEF film is pressed into the partially cured encapsulant. The LED device containing the irradiated encapsulant is then placed on a hotplate set at 100° C. for 30 seconds. The BEF film is peeled off the encapsulant. Examination of the light emitting device using a microscope shows a series of prisms on the surface of the encapsulant.

Various modifications and alterations to the invention will become apparent to those skilled in the art without departing from the scope and spirit of the invention.

What is claimed is:

1. A method of making a light emitting device, the method comprising:
providing a light emitting diode;
contacting the light emitting diode with a photopolymerizable composition comprising:
a silicon-containing resin comprising silicon-bonded hydrogen and aliphatic unsaturation, and
a metal-containing catalyst that may be activated by actinic radiation; and
contacting the photopolymerizable composition with a mold.

2. The method of claim 1, further comprising:
applying actinic radiation to the photopolymerizable composition after contacting it with the mold,
wherein the actinic radiation is at a wavelength of 700 nm or less and initiates hydrosilylation within the silicon-containing resin, the hydrosilylation comprising reaction between the silicon-bonded hydrogen and the aliphatic unsaturation.

3. The method of claim 2,
wherein applying the actinic radiation comprises forming a partially polymerized composition, and
the method further comprising heating the partially polymerized composition to further initiate hydrosilylation within the silicon-containing resin.

4. The method of claim 1, further comprising:
heating the photopolymerizable composition to a temperature of less than about 150° C. before contacting it with the mold.

5. A method of making a light emitting device, the method comprising:
providing a light emitting diode;
contacting the light emitting diode with a photopolymerizable composition comprising:
a silicon-containing resin comprising silicon-bonded hydrogen and aliphatic unsaturation, and
a metal-containing catalyst that may be activated by actinic radiation;
applying actinic radiation to the photopolymerizable composition, wherein the actinic radiation is at a wavelength of 700 nm or less and initiates hydrosilylation within the silicon-containing resin, thereby forming a partially polymerized composition, the hydrosilylation comprising reaction between the silicon-bonded hydrogen and the aliphatic unsaturation; and
contacting the partially polymerized composition with a mold.

6. The method of claim 5, further comprising:
applying actinic radiation to the partially polymerized composition after contacting it with the mold, wherein the actinic radiation applied to the partially polymerized composition is at a wavelength of 700 nm or less and further initiates hydrosilylation within the silicon-containing resin.

7. The method of claim 6,
wherein the applying actinic radiation to the partially polymerized composition comprises forming a second partially polymerized composition, and
the method further comprising heating the second partially polymerized composition to further initiate hydrosilylation within the silicon-containing resin.

8. The method of claim 5, further comprising:
heating the partially polymerized composition to a temperature of less than about 150° C. after contacting it with the mold,
wherein heating further initiates hydrosilylation within the silicon-containing resin.

9. The method of claim 1 or 5, wherein the mold is transparent to the actinic radiation.

10. The method as in any one of claims 2, 5 and 6, wherein applying actinic radiation comprises activating the light emitting diode.

11. The method of claim 1, the mold comprising a mold material and being shaped to impart a positive or negative lens on a substantial portion of the surface of the photopolymerizable composition.

12. The method of claim 1, the mold comprising a mold material and being shaped to impart macrostructures, each macrostructure having a dimension of from 10 um to 1 mm.

13. The method of claim 1, the mold comprising a mold material and being shaped to impart microstructures, each microstructure having a dimension of from 100 nm to less than 10 um.

14. A method of making a light emitting device, the method comprising:
providing a light emitting diode;
contacting the light emitting diode with a photopolymerizable composition comprising:
a silicon-containing resin comprising silicon-bonded hydrogen and aliphatic unsaturation, and
a metal-containing catalyst that may be activated by actinic radiation;
shaping a surface of the photopolymerizable composition by contacting it with a mold;
applying actinic radiation having a wavelength of 700 nm or less to initiate hydrosilylation within the silicon-containing resin, thereby forming a photopolymerized composition, wherein hydrosilylation comprises reaction between the silicon-bonded hydrogen and the aliphatic unsaturation; and
separating the mold from the photopolymerized composition.

15. A light emitting device prepared according to the method of claim 14.

16. A light emitting device comprising:
a light emitting diode;
a photopolymerizable composition comprising:
a silicon-containing resin comprising silicon-bonded hydrogen and aliphatic unsaturation, and
a metal-containing catalyst that may be activated by actinic radiation; and
a mold.

17. The light emitting device of claim 16, wherein the photopolymerizable composition is partially polymerized.

18. A light emitting device comprising:
a light emitting diode;
a photopolymerized composition in contact with the light emitting diode and formed from a photopolymerizable composition comprising:
a silicon-containing resin comprising silicon-bonded hydrogen and aliphatic unsaturation, and
a metal-containing catalyst that may be activated by actinic radiation,
wherein a surface of the photopolymerized composition is shaped as a positive or negative lens on a substantial portion thereof.

19. A light emitting device comprising:
a light emitting diode;
a photopolymerized composition in contact with the light emitting diode and formed from a photopolymerizable composition comprising:
a silicon-containing resin comprising silicon-bonded hydrogen and aliphatic unsaturation, and
a metal-containing catalyst that may be activated by actinic radiation, wherein a surface of the photopolymerized composition is shaped with macrostructures, each macrostructure having a dimension of from 10 um to 1 mm.

20. A light emitting device comprising:
a light emitting diode;
a photopolymerized composition in contact with the light emitting diode and formed from a photopolymerizable composition comprising:
a silicon-containing resin comprising silicon-bonded hydrogen and aliphatic unsaturation, and
a metal-containing catalyst that may be activated by actinic radiation,
wherein a surface of the photopolymerized composition is shaped with microstructures, each microstructure having a dimension of from 100 nm to less than 10 um.
